(19) United States
(12) Patent Application Publication
(10) Pub. No.: US 2018/0036699 A1
(43) Pub. Date: Feb. 8, 2018

(54) METHODS FOR SELECTING A LOADING PRESSURE DROP TOLERANCE SPECIFICATION FOR A MULTITUBULAR FIXED-BED REACTOR

(71) Applicant: SHELL OIL COMPANY, Houston, TX (US)

(72) Inventors: Gary James WELLS, Katy, TX (US); Jaafar Salih Ahmad EL-MASRI, Dubai (AE)

(21) Appl. No.: 15/228,047

(22) Filed: Aug. 4, 2016

(51) Int. Cl. B01J 8/00; B01J 19/24; B01J 8/06

(52) U.S. Cl. CPC B01J 8/001; B01J 8/06; B01J 19/2425; B01J 2208/00539; B01J 2208/06; B01J 2208/027

(57) ABSTRACT

A method for a selecting a loading pressure drop tolerance specification for a plurality of tubes in a multitubular fixed-bed reactor, wherein the plurality of tubes comprise a packed bed of epoxidation catalyst, the method comprising: defining a first loading pressure drop tolerance range for the plurality of tubes based on a desired maximum variation in outlet oxygen concentration, relative to the mean, for the plurality of tubes; defining a second loading pressure drop tolerance range for the plurality of tubes based on a desired maximum number of tube corrections for the plurality of tubes; and selecting the loading pressure drop tolerance specification for the plurality of tubes such that the entirety of the loading pressure drop tolerance specification falls within the first loading pressure drop tolerance range and the second loading pressure drop tolerance range.

### BACKGROUND

Multitubular fixed-bed reactors are widely used throughout the chemical and refining industries for gas-phase catalytic reactions where high levels of heat transfer are needed. Within a multitubular fixed-bed reactor, catalyst particles are typically arranged in a packed bed within a plurality of parallel tubes, with the gaseous reactants being passed through the tubes and reacting in the presence of the catalyst to form the reaction product. For example, in the commercial production of ethylene oxide, a gaseous feed comprising ethylene and oxygen is passed through a plurality of tubes comprising a packed bed of silver-based epoxidation catalyst to react and form ethylene oxide.

In the context of commercial ethylene oxide production, a modern multitubular fixed-bed reactor may contain several thousands of tubes and the process of loading catalyst into the tubes can take weeks, which is costly in terms of time and plant productivity. Over the past several decades, catalyst loading contractors have developed and improved methods of catalyst loading to reduce the time required to load the tubes and also to improve uniformity. Indeed, uniform loading of epoxidation catalyst from tube to tube is critical to future operation of the catalyst because when tubes have differing packing densities, the resistance to flow can vary, which leads to variations in residence time and differences in reactivity. Such reactivity differences can result in poor catalyst performance, thereby causing a reduction in product yield and economic penalty in the plant, or instability due to potentially flammable mixtures leaving tubes that have relatively lower conversion of the oxygen raw material.

In practice, catalyst loading uniformity is typically evaluated by measuring the uniformity of pressure drop (ΔP) across the tubes after loading. In general, if a tube has a lower degree of packing than the mean, which is reflected by a lower loading pressure drop relative to the mean, the tube will also tend to have a higher flow and lower residence time when the reactor is operated in the process. Such a “low ΔP” tube consequently will tend to convert less oxygen, and therefore the outlet oxygen concentration will generally be higher than a tube of average loading characteristics. In such a case, if the outlet oxygen concentration of the low ΔP tube is high enough, the local gas exiting the tube could enter the flammable region and potentially lead to an ignition and operational problems. Conversely, if a tube has a higher degree of packing than the mean, which is reflected by a higher loading pressure drop relative to the mean, the “high ΔP” tube will tend to have a lower flow, increased residence time, and higher oxygen conversion. If such a case occurs, it can eventually lead to a high degree of heat generation that the coolant system cannot effectively remove.

Ideally, the packing density in all the tubes would be the same immediately after catalyst loading, with no variation in the loading pressure drop from tube to tube. However, in reality, it is not possible to achieve perfect uniformity and variations in the loading pressure drop between tubes are encountered. Therefore, in practice, the level of precision for loading is oftentimes established by choosing a maximum allowable deviation from the mean loading pressure drop and if a tube's loading pressure drop falls outside of the range of this tolerance specification, the tube is typically reloaded or otherwise corrected.

Tube corrections may be done by a variety of means, including removing catalyst from the tube and reloading, adding/removing catalyst, using high pressure air to blow dust out of the tubes, etc. However, such corrections can be time consuming and costly and therefore it is desirable to limit the number of tube corrections as much as possible. Accordingly, when a plant is establishing its loading pressure drop tolerance specification, it would be preferable to use a structured set of criteria that balances loading effort/cost and future operability issues.

### SUMMARY

The present disclosure generally relates to methods for selecting a loading pressure drop tolerance specification for a plurality of tubes in a multitubular fixed-bed reactor. More particularly, the present disclosure provides methods for selecting a loading pressure drop tolerance specification for a plurality of tubes in a multitubular fixed-bed reactor, wherein the plurality of tubes comprise a packed bed of epoxidation catalyst.

In one embodiment, the present disclosure provides a method for selecting a loading pressure drop tolerance specification for a plurality of tubes in a multitubular fixed-bed reactor, wherein the plurality of tubes comprise a packed bed of epoxidation catalyst, the method comprising:
defining a first loading pressure drop tolerance range for the plurality of tubes based on a desired maximum variation in outlet oxygen concentration, relative to the mean, for the plurality of tubes;
defining a second loading pressure drop tolerance range for the plurality of tubes based on a desired maximum number of tube corrections for the plurality of tubes; and
selecting the loading pressure drop tolerance specification for the plurality of tubes such that the entirety of the loading pressure drop tolerance specification falls within the first loading pressure drop tolerance range and the second loading pressure drop tolerance range.

The features and advantages of the present disclosure will be apparent to those skilled in the art. While numerous changes may be made by those skilled in the art, such changes are within the spirit of the invention.

### DRAWINGS

Some specific example embodiments of the disclosure may be understood by referring, in part, to the following description and the accompanying drawings.

FIG. 1 is a plot correlating loading pressure drop variation to predicted outlet oxygen concentration variations for Reactor A.

FIG. 2 is a graph showing the frequency distribution of the pre-correction loading pressure drop for the tubes of Reactor A.

FIG. 3 is a plot correlating the loading pressure drop variation to the number of tube corrections for Reactor A.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DETAILED DESCRIPTION

The methods provided herein enable the selection of a loading pressure drop tolerance specification for a plurality of tubes in a multitubular fixed-bed epoxidation reactor such that the corresponding level of precision achieved for catalyst loading uniformity is a favorable balance between effort/cost and future operability of the epoxidation catalyst. Without such methods, catalyst loading uniformity can either be taken as-is from the initial loading, which can lead to future operability issues, or alternatively, corrections can be made to an arbitrary level of precision. However, an arbitrary choice for the loading pressure drop tolerance specification is not desirable as it can lead to future operational issues if not stringent enough, or lead to excess time/costs if more stringent than necessary.

An important aspect of the present disclosure is the recognition that an optimal loading pressure drop tolerance specification may be selected by balancing at least the following two considerations: (1) the impact of tube-to-tube variations in loading pressure drop on the variations in outlet oxygen concentration, and (2) the impact of the loading pressure drop tolerance specification on the required number of tube corrections. Particularly, it has been found that variations in loading pressure drop can be correlated to the difference in outlet oxygen concentration from tube-to-tube that is expected during normal operation. These outlet oxygen concentration variations can impact both catalyst performance and the potential for flammable gases to exit tubes, which can cause ignitions, subsequently reducing plant uptime/yield. Accordingly, the methods provided herein enable the selection of a loading pressure drop tolerance specification that takes into consideration both the maximum desired variation in outlet oxygen concentration from tube-to-tube, and the maximum desired number of tube corrections. By combining the analysis from both of these considerations, an optimal range for the loading pressure drop tolerance specification can be defined.

In accordance with the methods of the present disclosure, a first loading pressure drop tolerance range is defined based on a selection of a desired maximum variation in outlet oxygen concentration, relative to the mean. In general, the maximum variation in the outlet oxygen concentration, relative to the mean, should be selected such that the anticipated outlet oxygen concentration under normal operating conditions is less than the concentration of oxygen that would form a flammable mixture at the reactor outlet. Typically, the desired maximum variation in the outlet oxygen concentration is selected such that it is consistent with the plant's desired operational goals and operational window. Often, in practice, the outlet oxygen concentration in the reactor outlet gas is typically no greater than a pre-defined margin in oxygen concentration relative to a flammable mixture at the reactor outlet at the prevailing operating conditions (e.g., 0.7% or 0.5% oxygen concentration margin relative to flammability). Although the value selected for the desired maximum variation in the outlet oxygen concentration may vary over a wide range, the desired maximum variation, relative to the mean, is generally selected to be less than the pre-defined oxygen concentration margin relative to flammability. For example, the desired maximum variation in the outlet oxygen concentration is typically selected to be no more than ±0.4 mol %, or no more than ±0.3 mol %, or no more than ±0.2 mol %, or no more than ±0.1 mol %, or no more than no more than ±0.05 mol %.

The first loading pressure drop tolerance range is typically defined with the aid of a catalyst performance model, which is used to estimate the impact of loading pressure drop variations on outlet oxygen concentrations as a function of operating temperature and other operating conditions (e.g., desired ethylene oxide production, feed gas composition, GHSV, age of catalyst, etc.). A plot correlating the loading pressure drop variations to the estimated outlet oxygen concentration variation may be prepared, using the data generated by the catalyst performance model, and used to define the first loading pressure drop tolerance range based on the desired maximum variation in outlet oxygen concentration that was selected.

Further, in accordance with the methods of the present disclosure, a second loading pressure drop tolerance range is defined based on a selection of a desired maximum number of tube corrections. The desired maximum number of tube corrections may be specified either in terms of a desired maximum whole number of tubes to be corrected or a desired maximum percentage of tubes to be corrected, relative to the total amount of tubes present in the reactor. In general, as the selected desired maximum number of tube corrections decreases, the corresponding range for the second loading pressure drop tolerance range will increase. This is to be expected because typically, when a more narrow range is specified for the loading pressure drop tolerance range, more tubes will need to be corrected. Although the desired maximum number of tube corrections may vary over a wide range, depending, at least in part, on the number of tubes inside the reactor, the desired maximum number of tube corrections is typically no more than 20%, preferably no more than 10%, more preferably no more than 5%, or no more than 4%, or no more than 3%, or no more than 2%, or no more than 1%.

The second loading pressure drop tolerance range is typically defined with the aid of a frequency distribution analysis, which shows the frequency of the loading pressure drop for the tubes in the reactor, as measured using standard methods and before any corrections are made. The frequency distribution analysis may either be based on distribution estimates from historical data, or based on actual pre-correction loading pressure drop measurements taken for the tubes in the reactor. A plot correlating the loading pressure drop variations to the number of tube corrections may be prepared, using the data provided in the frequency distribution analysis, and used to define the second loading pressure drop tolerance range based on the desired maximum number of tube corrections that was selected.

After a first and second loading pressure drop tolerance range have been defined, a loading pressure drop tolerance specification for the plurality of tubes can be selected. The loading pressure drop tolerance specification should be selected such that the entirety of the loading pressure drop tolerance specification falls within the defined first and second loading pressure drop tolerance ranges. That is to say, the loading pressure drop tolerance specification should be selected such that it completely overlaps with both the first and second loading pressure drop tolerance ranges. In this way, the methods provided herein enable the selection of loading precision criteria that provide a favorable balance between effort/cost and future operability of the epoxidation catalyst.

To facilitate a better understanding of the present invention, the following examples of certain aspects of some embodiments are given. In no way should the following examples be read to limit, or define, the entire scope of the invention.

### EXAMPLE

This Example describes the selection of a loading pressure drop tolerance specification for Reactor A, which has approximately 4000 tubes.

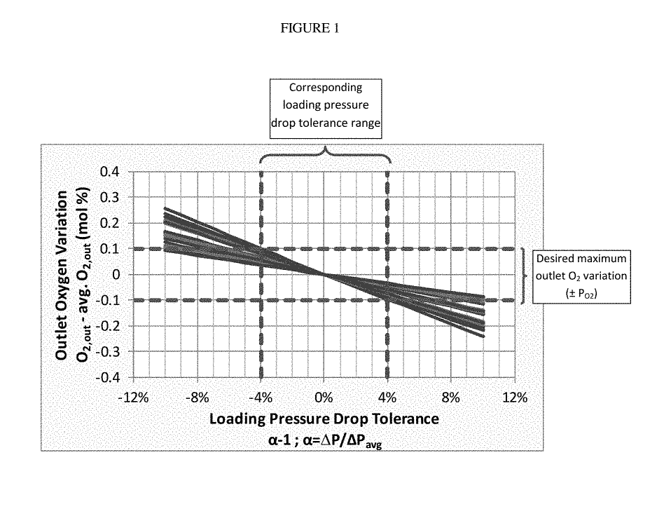

To define the first loading pressure drop range, a plot correlating the loading pressure drop variations to the estimated outlet oxygen concentration variation, as shown in FIG. 1, was prepared. The impact of the loading pressure drop variations were first applied to GHSV (gas hourly space velocity) using the following relationship:

GHSV=GHSV_{avg}/α^{0.5}, wherein:
GHSV represents the gas hourly space velocity of a particular tube during normal operation,
GHSV_{avg} represents the average value for GHSV during normal operation, and
α=ΔP/ΔP_{avg}, wherein ΔP is the loading pressure drop for a particular tube and ΔP_{avg} is the average value for loading pressure drop over all reactor tubes.

A catalyst performance model was then used to estimate the impact of the loading pressure drop variations on outlet oxygen concentration for a given operating temperature and other operating conditions (desired delta EO, feed compositions, etc.). Such an analysis was done for a variety of levels of a, for fresh and aged catalyst, and for a wide range of other operating conditions representing normal EO reactor operation.

The plot shown in FIG. 1, which correlates the loading pressure drop variations to the predicted outlet oxygen concentration variation for a variety of operating conditions of interest for fresh and aged catalyst, was prepared using the data generated by the catalyst performance model. The horizontal axis of FIG. 1 is (α−1), or the loading pressure drop variation, relative to the mean. The vertical axis of FIG. 1 is the predicted outlet oxygen concentration variation, relative to the mean. As can be seen in FIG. 1, the outlet oxygen concentration variation, relative to the mean, varies inversely with the value of (α−1). In other words, as the loading pressure drop of a tube increases relative to the mean, the outlet oxygen concentration will decrease; this is due to increased residence time and oxygen conversion over the tube.

The plot of FIG. 1 was used to assess the trade-off between loading pressure drop variation and the predicted outlet oxygen concentration variations that result. An acceptable level of the outlet oxygen concentration variation (±P_{O2}) was selected to be ±0.1 mol % O₂ (see the horizontal lines labeled on FIG. 1). In general, a plant is free to choose a level of outlet oxygen concentration variation consistent with their operational goals and operational window. The corresponding span of the first loading pressure drop tolerance range was defined using the plot by translating the most extreme cases (+0.1 mol % and −0.1 mole %) to the horizontal axis. In this example, as reflected in FIG. 1, the first loading pressure drop tolerance range was defined as approximately ±4%.

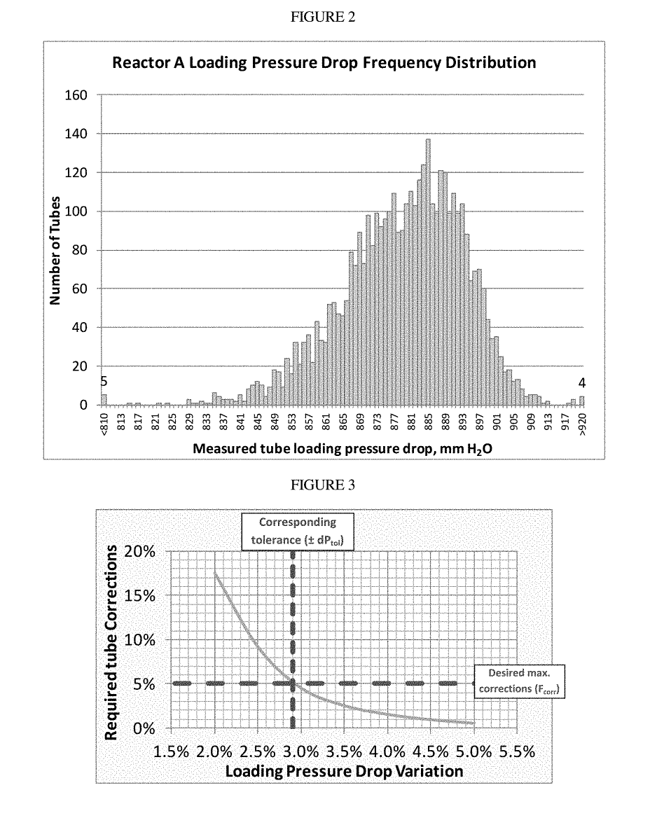

Next, a second loading pressure drop tolerance range was defined based on a desired maximum number of tube corrections. In determining the desired maximum number of tube corrections, a frequency distribution graph as shown in FIG. 2 was used. FIG. 2 shows the frequency distribution of loading pressure drop for the tubes in Reactor A in units of mm H₂O, as measured after loading catalyst using standard methods (this analysis methodology equally applies to a variety of methods and units for measuring the loading pressure drop). The frequency distribution chart of FIG. 2 was based on pre-correction loading pressure drop measurements taken for the tubes in Reactor A.

Using the data provided in the frequency distribution analysis, a plot correlating the loading pressure drop variation to the number of tube corrections relationship was prepared, as shown in FIG. 3. A desired maximum number of tube corrections of 5% was selected and the corresponding span of the second loading pressure drop tolerance range was defined using the plot. As shown in FIG. 3, a 5% tube correction specification corresponds to a loading pressure drop tolerance range of no narrower than ±2.9%.

A loading pressure drop tolerance specification for Reactor A was then selected such that the entirety of the loading pressure drop tolerance specification was within the defined first and second loading pressure drop tolerance ranges. As noted, specific values of ±0.1% for the desired maximum variation in outlet oxygen concentration and 5% for the desired maximum number of tube corrections were selected. For the first loading pressure drop tolerance range, based on the outlet oxygen concentration variation, this led to a maximum of ±4.0%, and for the second loading pressure drop tolerance range, based on the maximum number of tube corrections, this led to a minimum of ±2.9%. Overall, the loading pressure drop tolerance specification was then selected to be ±2.9-4.0% loading pressure drop.

It should be noted that this is only one example of application of this methodology. Other specifications can also be chosen depending on plant goals for the desired levels of O₂ variation and tube corrections, as long as the choices still lead to an acceptable range of overlap. Similarly, this analysis assumes symmetric specifications of the percentage range around zero are made for both the first and second loading pressure drop tolerance ranges. By simple extension of the concepts given here and corresponding analysis of the available data, asymmetric assumptions can also be made if desired.

Another potential extension to this analysis is to define costs associated with variations in the outlet oxygen concentration as well as with the number and/or nature of tube corrections. Such costs would vary with specific site operations and cost structures. However, with the definition of appropriate cost relationships, a loading pressure drop tolerance specification can be selected that minimizes the sum of the operational costs from outlet oxygen concentration variations and the loading-related costs that arise from tube corrections. The loading pressure drop tolerance specification that minimizes the sum of these costs would further refine the tolerance range in a way that is economically optimal.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method for a selecting a loading pressure drop tolerance specification for a plurality of tubes in a multitubular fixed-bed reactor, wherein the plurality of tubes comprise a packed bed of epoxidation catalyst, the method comprising:
defining a first loading pressure drop tolerance range for the plurality of tubes based on a desired maximum variation in outlet oxygen concentration, relative to the mean, for the plurality of tubes;
defining a second loading pressure drop tolerance range for the plurality of tubes based on a desired maximum number of tube corrections for the plurality of tubes; and
selecting the loading pressure drop tolerance specification for the plurality of tubes such that the entirety of the loading pressure drop tolerance specification falls within the first loading pressure drop tolerance range and the second loading pressure drop tolerance range.

2. The method of claim 1 wherein the desired maximum variation in the outlet oxygen concentration is no more than ±0.4 mol %.

3. The method of claim 1 wherein the desired maximum variation in the outlet oxygen concentration is no more than ±0.2 mol %.

4. The method of claim 1 wherein the desired maximum variation in the outlet oxygen concentration is no more than ±0.1 mol %.

5. The method of claim 1 wherein the desired maximum number of tube corrections is no more than 10%.

6. The method of claim 1 wherein the desired maximum number of tube corrections is no more than 5%.

7. The method of claim 1 wherein the desired maximum number of tube corrections is no more than 3%.

8. The method of claim 1 wherein the desired maximum number of tube corrections is no more than 2%.

9. The method of claim 1 wherein the desired maximum number of tube corrections is no more than 1%.
